(19) United States
(12) Patent Application Publication
(10) Pub. No.: US 2013/0234501 A1
(43) Pub. Date: Sep. 12, 2013

(54) PISTON-CYLINDER DEVICE AND METHOD FOR CONDUCTING A HYDRAULIC FLUID UNDER PRESSURE TO AN ACTUATING DEVICE, ACTUATING DEVICE FOR A VEHICLE BRAKE SYSTEM, AND A METHOD FOR ACTUATING AN ACTUATING DEVICE

(71) Applicant: Heinz Leiber, Oberriexingen (DE)

(72) Inventor: Heinz Leiber, Oberriexingen (DE)

(73) Assignee: IPGATE AG, Pfaffikon Sz (CH)

(21) Appl. No.: 13/884,074

(22) PCT Filed: Oct. 6, 2011
(86) PCT No.: PCT/EP11/04994

§ 371 Date: May 30, 2013

(30) Foreign Application Priority Data
Nov. 8, 2010 (DE) 10 2010 050 508.0
Dec. 20, 2010 (DE) 10 2010 055 044.2

(51) Int. Cl. B60T 13/14; B60T 13/68; B60T 11/16

(52) U.S. Cl. CPC B60T 13/145; B60T 11/16; B60T 13/686
USPC 303/10; 303/28

(57) ABSTRACT

The invention relates to a piston-cylinder device for conducting a hydraulic fluid under pressure to an actuating arrangement, in particular a brake system, having at least one piston which delimits a pressure chamber, which is connected to the actuating arrangement via a hydraulic line. Provision is made according to the invention that the hydraulic fluid is conducted to the pressure chamber under pressure by means of an additional arrangement.

### PRIOR ART

The invention relates to a piston-cylinder device for delivering a hydraulic fluid, in particular for a vehicle brake system.

Piston-cylinder devices of this type are known for various purposes for delivering hydraulic fluid under pressure to a thus actuated device. In many cases, piston-cylinder devices of this type are more or less oversized in terms of their displacement volume in order to have sufficient stroke or hydraulic volume available for different applications.

Master cylinders for brake assemblies are known, for example, which are highly oversized in the event of fading or air in the brake circuit.

However, brake control systems are known from DE 102007062839, for example, in which the tandem master cylinder (TMC) is smaller and redelivery devices with hydraulic accumulator or delivery pistons coupled to the master cylinder piston supply additional volume to the brake circuit with corresponding control. The first only allows limited redelivery volume and the second is expensive.

There are also control systems where pressure is generated using TMC according to DE 195 38 794 and DE 103 18 401, in which the TMC is controlled as a delivery piston in order to compensate for the volume discharged from the brake circuit when the pressure falls through intake. Refilling control is provided for this purpose. Intake is via the piston sealing collar, which is known to open at approx. 0.5 bar, and consequently the actual negative pressure for intake, as also described, is reduced.

An arrangement is described in DE 102008051316 in which the brake piston is returned as a result of directed brief negative pressure in the wheel cylinder thus eliminating residual friction. Additional solenoid valves are required in the connecting line from the THC to the reservoir for this purpose.

The object to be achieved by the invention is to produce a piston-cylinder device for delivering a hydraulic fluid, in particular for vehicle brakes, with which the disadvantages of the prior art can be eliminated in a simple and effective manner.

This object is achieved according to the invention in that the hydraulic fluid is supplied to the pressure chamber under pressure by means of an additional arrangement.

The solution according to the invention is to provide a simple and effective delivery facility with overpressure which is not restricted in terms of the required delivery volume and which allows a high delivery rate.

This solution is also extremely advantageous at low temperatures;

problems can arise in known systems at such temperatures since the intake rate decreases in proportion to increasing viscosity. The redelivery operation can therefore be kept very short and consequently the resulting release of air can be prevented even if there is negative pressure over an extended period of time.

Intermittent operation of the delivery arrangement is advantageous. Said arrangement can be used particularly in brake systems for different delivery pistons, preferably tandem master cylinders, where intake or delivery can be performed via sleeves or additional solenoid valves. The delivery arrangement can work separately for each hydraulics or preferably brake circuit.

Advantageous embodiments or designs of the invention and the associated further advantages result from the following embodiments or further claims respectively.

In an extended configuration of the TMC, the sleeves should no longer open when there is negative pressure and consequently negative pressure control using the TMC pistons is necessary for brake lining ventilation control without additional non-return valves to the reservoir.

A preferably electromagnetic preliminary pump between the reservoir and the tandem cylinder is suggested as delivery arrangement, which is actuated when the TMC piston (s) are returned. Magnetic force acts on the pump pistons during this intake phase and generates the required excess pressure. The turn on and off times of the magnets are adjusted according to piston movement. According to the prior art, different pump embodiments are conceivable with or without intake valves. Preferably, a pump without valves is suggested in which the pump piston is arranged in a similar way as in a TMC. Here the snifting bore lies behind the sleeve and the bore then closes after the collar has passed over it. The pressure load (already low pressure<10 bar) can be optimised by moving the MC piston first before the pump piston start. The snifting bore is then already in the uncritical sleeve pressure range.

When using an electromagnetic preliminary pump, the aforementioned piston collar that is resistant to negative pressure can be dispensed with by activating the backing pump at the desired negative pressure control to control brake lining ventilation. This also closes the connection from the TMC to the reservoir.

The preliminary pump can also be used in a system configuration according to DE 103 18 401, for example, where intake is via the MC sleeve. Here, the preliminary pump effects a considerably shorter intake or refilling operation using excess pressure. In other system configurations, a TMC with 2/2 solenoid valve in the line from the brake circuit to the reservoir is activated. Here the preliminary pump can support the intake operation directly in the brake circuit or according to the sleeve configuration also parallel via the sleeve. There is also the option in said TMC configuration to simplify the design by only providing preferably a small snifting bore in the MC pistons. This reduces sleeve friction and there is less free travel of the TMC.

There is a further option with said TMC configuration to activate both preliminary pumps at the same time to control the redelivery operation by activating the 2/2 solenoid valve individually per brake circuit. The preliminary pump can be incorporated into the TMC housing or with the reservoir.

The free travel of the TMC to the point of application of the brake linings even taking account of the level course of the pressure volume characteristic is known to be extremely flat in the low pressure range. If the preliminary pump is activated at the same time, upon or prior to activation of the TMC, free travel can be reduced significantly which leads to a desired more rigid pedal characteristic.

The preliminary pump is also suitable in half-open systems with a slightly loose solenoid valve which is activated to reduce pressure in a reservoir. In such half-open systems, there is a safety problem in known solutions if a solenoid valve becomes loose releasing pressurising agents into the reservoir when there is a loss of pressure. Leakage flow can be countered advantageously in the invention by the pump that functions intermittently.

Since the TMC is located in the crash zone, the projecting magnet portion can be fixed such that it cannot be easily sheared in the event of a crash and thus does not act as a rigid barrier.

Since compared with the position of the push rod piston in the TMC, which is measured via the turning angle transmitter of the brake servo unit, the position of the accumulator chamber piston is not determined, said position can be determined using a simple contact-free sensor. Determining a region in which redelivery is made is sufficient.

Exemplary embodiments of the invention and their embodiments as well as further advantages and features are shown in the drawings and described below.

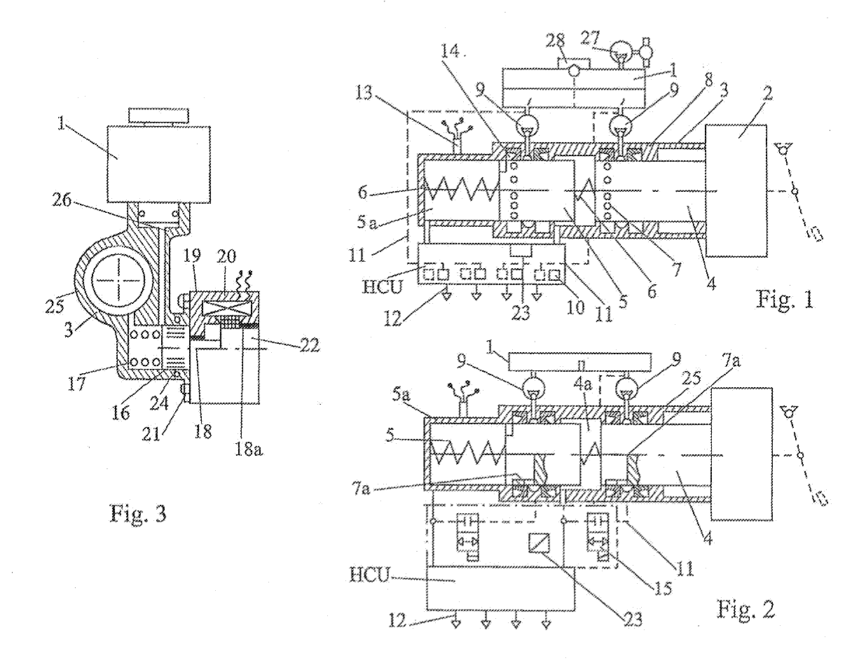

FIG. 1 shows a piston-cylinder device as part of an actuating arrangement for a vehicle brake system;

FIG. 2 shows a piston-cylinder device according to FIG. 1, however with an arrangement for multiplex operation;

FIG. 3 shows a pump integrated into a piston-cylinder device;

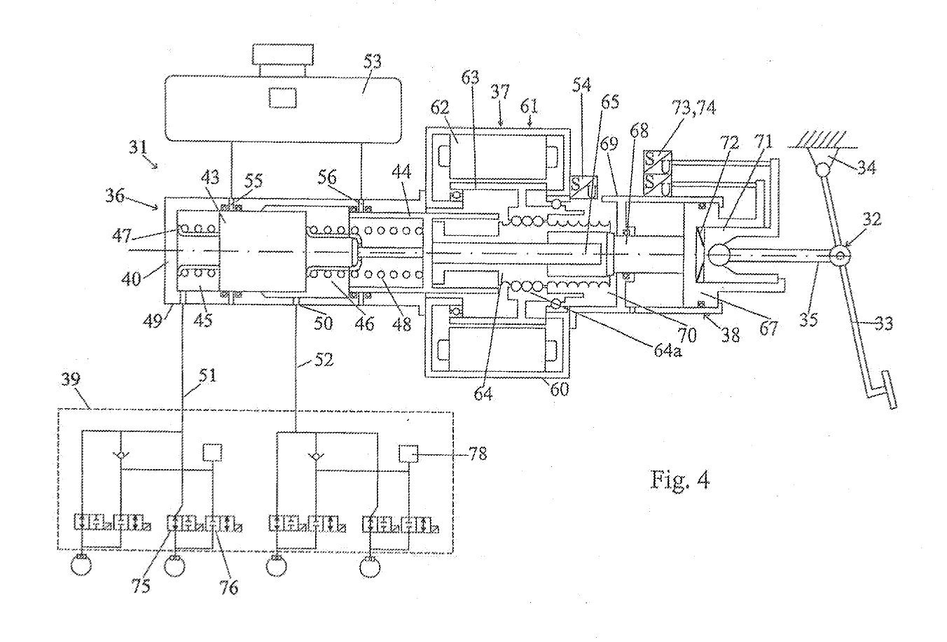

FIG. 4 shows a first embodiment of an actuating device for a vehicle brake system;

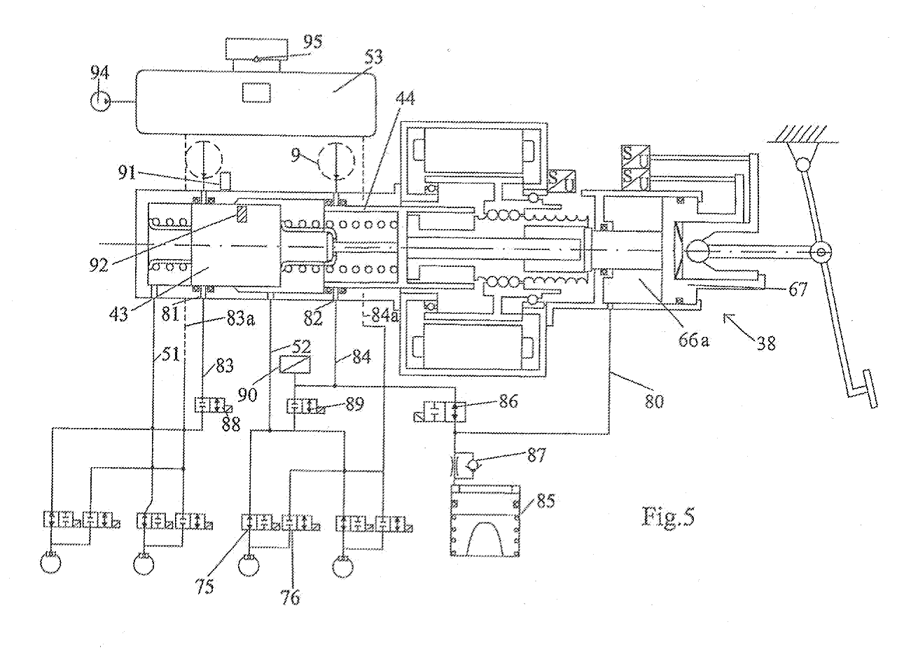

FIG. 5 shows a second embodiment of an actuating device with a distance simulator;

FIG. 1 shows the known arrangement of a TMC with housing reservoir 1, power assist 2, which can be a power assist with or without a pedal, i.e. with separate actuating unit or with or without travel simulator, housing 3, two sealing sleeves 8 per piston, push rod piston 4, accumulator chamber piston 5 with piston return spring 6. The preliminary pump 9 is arranged in the connecting line between TMC 23 and reservoir 1. The snifting bores 7 are applied in large numbers in pistons in modern TMC and are located behind the sealing sleeve when the piston is in its initial position. If the control arrangement that is not shown requires the redelivery of volume to the hydraulic circuits 4a and 5a, then upon corresponding HCU valve control, with closing of the connection between the TMC and the wheel brake 2, the piston is returned which, in the event of negative pressure, leads to an intake of brake fluid from the reservoir, for example. The TMC and piston respectively are controlled accordingly in this embodiment and in other embodiments for the redelivery of hydraulic volume. The preliminary pump 9 is activated at the same time or slightly later and generates the desired excess pressure to increase delivery rate or shorten the intake or delivery operation. A delivery pump is used preferably for each hydraulic circuit.

Valve circuits are used in the HCU, which effect a build-up of pressure via the inlet valves indicated and a reduction in pressure via outlet valve 10 into the corresponding return lines 11 to the reservoir. The volume extracted from the wheel cylinder for the purpose of reducing pressure must be generated by the TMC piston when the increase in pressure follows. Since the volume for ABS function is 3-5 cm³/s, at 20 s control time, the TMC needed to be far too big. Consequently, redelivery of the volume takes place in accordance with the criteria already described at intermittent intervals as described above.

The position of the push rod piston 4 is generally determined by the turning angle sensor of the brake servo unit 2 and consequently a position for redelivery can be specified here. The position is not reported to the accumulator chamber piston. Only the end position can be assessed from the pressure increase gradient of the pressure sensor 23 in the push rod piston circuit compared with the push rod piston position.

An interim position can only be estimated from the control signal as described.

It is expedient for safety reasons to determine the position of the accumulator chamber piston 5 via a target 14 using a sensor which can be determined easily using an Hall sensor and permanent magnet as target 14 in the piston. These means can be used to achieve rapid redelivery where the pistons are in a safe position and where there is still sufficient volume for emergency braking in the event of the malfunction of the brake servo unit 2, via the brake pedal for example. Preferably a brake servo unit with travel simulator according to DE102005018649 is used here to which full reference is made herein for disclosure purposes.

The embodiment according to FIG. 2 has the same design in respect of brake servo unit and TMC. The HCU is designed in accordance with so-called multiplex operation as described in DE 102005055751 to which full reference is made herein for disclosure purposes, and thus the outlet valve is not necessary since pressure is built up and reduced through corresponding piston control. These systems require an additional 2/2-way solenoid valve 15 in the connection between brake circuit 4a and 5a and the reservoir via line 11. This valve is necessary, for example, for so-called free travel clearance as described in DE 102005055751 to which full reference is made herein for disclosure purposes, upon which volume from the brake circuit is discharged into the reservoir via the solenoid valve 15 so that the push rod piston moves forwards and there is no collision with the indicated brake pedal or its push rod respectively. If there is redelivery in this system, this can be performed via said solenoid valve 15 and the line 11. Since rapid snifting or redelivery takes place via the preliminary pump 9 via the solenoid valves 15 for both circuits, only a small snifting bore 7a can be used which considerably improves sleeve friction as the main cause of THC malfunction. There is also correspondingly less free travel. This small snifting bore ensures temperature adjustment in a stationary vehicle. In this context, the sealing sleeve 8 can be more rigid in design, i.e. resistant to negative pressure. This is advantageous for brake lining ventilation control using negative pressure in order to save on two solenoid valves in the connecting line to the reservoir. Alternatively, this is not necessary if the preliminary pump 9 is activated during this operation. Thus the connection between the TMC and the reservoir 1 is separate. By means of corresponding control of the valves in the HCU and the TMC pistons, the brake pistons can be controlled individually via negative pressure in order to prevent greater friction on the brake lining.

Redelivery can take place via the separate preliminary pump 9 individually per brake circuit. Both backing pumps can be activated together to save costs; the brake circuits are controlled individually via the 2/2 solenoid valves 15.

The option for redelivery on initial braking has already been described above.

FIG. 3 describes the arrangement and design of the preferably electromagnetically activated pump, integrated into the TMC housing in this exemplary embodiment. This is particularly advantageous if the pump pistons with seal have a similar design to the TMC pistons. The piston bore can be made using the same or similar tools in a clamping device.

In FIG. 3 the pump is shown principally from the outside having pistons 16, return spring 17 and seal 24. The pump pistons are in the starting position where the snifting bore 7a is connected to the piston chamber 4a, 5a via the radial groove 25 and the intake channel 26 to the reservoir. When the solenoid 20 is activated, magnetic flux is generated accordingly via the magnetic circuit 19 and the rotor 22 effects the corresponding magnetic force on the pistons 16 to control the pressure.

The rotor is mounted twice in the bearing sleeve 18 and front bearing 18a which is integrated into the solenoid body. The magnetic circuit can have the standard poles to generate greater initiating force. The magnetic circuit can be designed as round or flat from laminated panels which reduces magnetic losses, saves construction space and improves response time. In this arrangement the magnet housing projects into the space at risk in the event of a crash. Therefore, the housing flange or attachment 21 can be designed such that this zone is soft for the crash sequence, i.e. can be sheared.

The TMC can be considerably smaller in size in a rapid delivery arrangement since it can actually only be designed for the fall-back level at approx. 100 bar. If higher pressure is needed with the brake servo unit, for fading, for example, a higher pressure level of 150 bar can be redelivered in approx. 50 ms. This dwell time has a negligible effect on the braking distance which is good for the chassis in the event of long delays, a transient effect for further pressure control.

Many functions can be performed with this preliminary pump at low cost.

The invention relates to an actuating arrangement for a vehicle braking system which, advantageously, can have a delivery device as described above and below.

A further hydraulic piston-cylinder unit is provided here, which can be actuated by the actuating arrangement and the first piston-cylinder unit can be actuated by means of the servo unit in order to feed hydraulic fluid into the brake circuit.

An actuating device is already known from the “Brake Manual”, 1^{st} edition, Vieweg Verlag, wherein the servo unit is a vacuum brake servo unit. A hydraulic aggregate (HCU) has an inlet valve and an outlet valve on each wheel brake. Furthermore, accumulator chambers are assigned to the brake circuits in the HCU and a redelivery pump driven by an electric motor is provided to feed the brake fluid in the accumulator chambers back to the TMC. The redelivery pump is a piston pump which causes pressure pulsations in the TMC. Additional damper chambers are provided to reduce the associated noise. Although parallel pressure control in the wheel brakes is possible with this device, it is expensive overall and is usually combined with a vacuum brake servo unit. However, this does not match the general trend which will be based on electric brake servos in the future.

The solution according to the invention involves an actuating device for vehicles which manages without a vacuum brake servo unit. A redelivery pump is also unnecessary in this solution thereby eliminating the problems associated with such pumps.

An accumulator is expediently provided in the actuating device and consequently the hydraulic fluid can be redelivered from the accumulator to the brake circuit. This configuration allows individual pressure reduction.

The servo unit advantageously has an electromotive drive wherein a gearing mechanism can be provided which in particular is coupled to the piston in the first piston-cylinder unit in a positive-fit or force-fit manner and consequently movements of the gearing mechanism in both directions are transferred to the pistons.

According to further embodiments the actuating device is connected to a travel simulator. Said travel simulator can be connected to a pressure chamber in the further piston-cylinder unit.

A mechanism that can be activated by the actuating arrangement, which has two elements that can be moved relative to each other between which an elastic element is arranged, is provided in further embodiments.

A further hydraulic line can expediently be provided in which a valve arrangement is activated, leading from the hydraulic line leading to the wheel brakes to the brake fluid reservoir in order to enable free travel clearance.

The actuating device 31 for a vehicle brake system shown in FIG. 4 has an actuating arrangement 32 which is provided in particular with a brake pedal 33 which is swivel-mounted on a bearing pedestal 34 and to which a push rod 65 is linked. The actuating arrangement 32 acts on a mechanism, which has a first piston-cylinder unit 36, a servo unit 37 and a transmission unit 38, which transfers the pedal force via the push rod 35 to the push rod piston 44. Furthermore, a hydraulic control unit (HCU) 39, various sensors and an electronic control unit ECU (not shown here) are provided.

The first piston-cylinder unit 36 has a housing 40 which is connected to the servo unit 37. Two pistons 43, 44 are arranged in the housing in an axially displaceable manner. The first piston (FP) 43 forms a first pressure chamber 45 and the second piston (PRP) 44 a second pressure chamber 46 and both thus form a tandem master cylinder (TMC). The pistons 43, 44 are supported on the housing and against each other via springs 47, 48. Openings 49, 50 are provided in the housing which lead to hydraulic lines 51, 52 that are connected to the HCU 39. Further openings 55, 56 in the housing 40 are sealed relative to the pistons 43, 44 and guide hydraulic lines to a brake fluid reservoir 53 at normal pressure. The piston 44 has recesses on both sides one of which receives the end of the spring 48.

The servo unit 37 connected to the first piston-cylinder unit 36 has a housing 40 in which an electric motor 61 with stator 62 and rotor 63 is arranged wherein the latter is rotatably mounted in the housing via bearings. A gearing mechanism or a mechanism for converting the rotational movement of the rotor 63 into a linear movement is arranged concentrically in the rotor. Said mechanism has a ball screw 64 here, which is arranged in the rotor in a torque proof and axially displaceable manner and which acts together with a spindle nut 64a, which is fixedly attached to the rotor. A push rod 65 is mounted on the spindle 64; a magnetic coupling can be provided on the end of said push rod facing the actuating mechanism. The front end of the ball screw is arranged here in the recess of the piston 44 which projects into the housing 60. The spindle 64 is fixedly attached to the pistons 44 via a magnetic coupling on the front end of the screw and consequently movements of the spindle in both directions are transferred to the pistons. A sensor 54 is provided to determine the rotational movement of the rotor 63.

The transmission unit 38 is mounted on the servo unit housing. This forms a recess 70 which receives the back end of the ball screw and the push rod 65. A space 66 is formed in the cylinder which receives a piston 67.

The piston 67 forms a central extension 68 which projects through an opening in the base of the cylinder 69 into the recess 70 in order to act together with the push rod 65.

The piston 67 forms a cylindrical recess in which an element 71 is arranged in an axially displaceable manner. An elastic member 72, for example a disc spring, flat spring or a rubbery elastic element or similar is arranged between the cylinder and the element 71. Two distance sensors 73, 74 are also provided in the transmission unit 38 which can be used to measure the distances covered by the piston 67 or the element arranged thereon 71. The corresponding values are delivered to the ECU in order to control the servo unit via the differential values proportional to pedal force. The push rod 35 in the actuating arrangement is connected to the element 71 via a universal joint and consequently movements are transmitted in both directions.

The HCU 39 provided between the TMC 36 and the wheel brakes FL, FR, RL, RR has various valves which are controlled by the ECU. Each of the wheel brakes is connected to a pressure chamber in the TMC. A currentless, open 2/2 way magnetic valve 75 is activated in this connection. A currentless, closed 2/2 way magnetic valve 76 is arranged in a connection leading from the wheel brake via a return valve 77 and via one of the hydraulic lines 51, 52 to the corresponding pressure chamber of the TMC and thus to the brake fluid reservoir 53. Furthermore, an accumulator chamber 78 is arranged in this connection upstream of the return valve 77. The valve configuration described above for a wheel brake FL is provided accordingly for the other wheel brakes FR, RL and RR as shown in the drawing.

The function of the device shown in FIG. 4 is described below based on the starting position shown:

Pressure builds up in the pressure chambers of the TMC 36 on activation of the device such that brake fluid can flow via the open valves 75 to the wheel brake cylinders thereby activating the wheel brakes. If the ABS is active, for example, the pressure can be kept constant by closing the valve 75 or reduced by opening the valve 76. When pressure is reduced, the brake fluid flows into the accumulator chamber 78. At certain intervals when the accumulator chamber is almost full, the TMC is returned via the servo unit drive as a result of which the accumulator chamber is emptied if the inlet valves are closed. The activation and corresponding control of the TMC to empty the accumulator can make a return pump, as normally used in such systems in the known cases, redundant. The inlet valves are designed such that they operate even in the event of great differential pressure on both sides. A return valve that is generally operated in parallel is not provided in said inlet valves.

In the event of a brake servo unit malfunction, foot power can be transmitted directly to the pistons 44 via the piston 67 or push rod 68 and push rod 65.

In the device shown in FIG. 5, the actuating arrangement, servo unit and TMC are substantially the same as in the device according to FIG. 4 and consequently no detailed description will be provided in this respect.

Unlike as in FIG. 4, in the embodiment according to FIG. 5, a hydraulic line 80 is provided, which connects the pressure chamber 66a via a currentless, open 2/2 way solenoid valve 86 and a hydraulic line 84 to the reservoir 53. The hydraulic line 84 is connected to the hydraulic line 52 via a currentless, closed 2/2 way valve 89 which leads to the pressure chamber 46 of the TMC, wherein the solenoid valve serves as a distance simulator. Openings 81, 82 are provided in the TMC to connect the line 84 and a corresponding line 83, where said openings open out into a line provided in the wall of the TMC, said line is connected to the reservoir via a hydraulic line. The line provided in the wall has a groove here which is sealed in relation to the TMC piston on both sides by means of seals. The connection with the reservoir 53 can also made via lines that do not lead through the TMC. Currentless, closed 2/2 way solenoid valves are arranged in the hydraulic lines 83, 84. When the hydraulic preliminary pump 9 is used, the return lines 83a and 84a lead directly to the reservoir 53. A pressure sensor 90 is also provided in the line 84. A hydraulic travel simulator 85 is also provided in this configuration which is connected to the line 80 via a currentless, open 2/2 way solenoid valve 86 and an arrangement 87 with throttle valve and return valve. The distance simulator 85, which has a piston that is moveable in a cylinder against a spring, generates the desired reaction on the pedal force in this configuration in accordance with the spring characteristic of the distance simulator spring. The arrangement 87 with throttle valve and return valve serves for speed and direction-dependent restriction for the purpose of good response characteristics. A piston travel sensor 91 with sensor target 92 is arranged on the piston on the TMC and the reservoir 53 is equipped with an air pump 94 and a return valve 95.

The function of the device shown in FIG. 5 is described below:

When the device is activated by the driver, the piston 67 in the figure is displaced to the left resulting in the build-up of pressure in the pressure chamber 66a and via the line 80 in the connected travel simulator. Depending on the pressure desired by the driver or the resulting braking effect, the servo unit becomes active as a result of the actuation of the engine and the gearing mechanism, which acts on the pistons 44 by means of the recirculating ball screw such that pressure builds up in the pressure chambers and in the brake circuits accordingly. The solenoid valves 75 and 76 (and the corresponding solenoid valves which are assigned to the other wheel brakes) act in terms of building-up, maintaining and reducing pressure, by opening and closing in a known manner in order to perform functions such as ABS and ESP. The TMC acts as described in FIG. 1 as a return pump. The decrease in pressure does not occur in the configuration according to FIG. 5 in an accumulator chamber, however, but rather via lines 58, 84 via the TMC into the reservoir 53. There is an option for design reasons to provide two connections for the return line to the reservoir 53.

The volume of hydraulic fluid corresponding to the decrease in pressure is discharged from the brake circuit and then delivered again via the movement of the TMC piston. For safety reasons, in the event of malfunction of the brake servo unit, there must always be enough hydraulic fluid in the master cylinder piston chambers or pressure chambers respectively. Consequently, following respective piston movement or upon indirect evaluation of the volume when pressure decreases, for example on the basis of the pressure decrease time, pressure level from pressure model and temperature are returned according to the piston. There is an intake of hydraulic fluid volume into the piston chamber when the inlet valve (s) 75 is closed.

Intake via the valves 88, 89 is possible even at lowest negative pressure. The solenoid valves 88, 89 are preferably provided with a large cross section for this purpose in order to keep intake resistance low. This reduces the intake time. It is a significant advantage here that in each control mode, pressure build-up or pressure reduction, the pressure is maintained for a brief period in order to perform the intake operation so that sufficient volume reaches the piston chambers again. Preferably, however, in a pressure maintenance stage the intake operation is performed at least for the front wheels.

The volume discharged from the wheel cylinder circuit is supplemented again by piston movement and the intake operation. The position of the pressure circuit piston 44 is known via the turning angle sensor 54 in the engine. Conversely, the position of the floating piston 43 can only be determined via the pressure using previous diagnosis and the aforementioned estimation of volume. Therefore, the travel sensor 91 can be provided in an expedient manner in order to establish the position of the piston 43. To simplify matters, evaluation of the position is sufficient which allows adequate residual volume for an increase in pressure even with fading. Preferably an echo sensor with a permanent magnet can be deployed on the piston.

To reduce the intake time, a pressure source 94, in particular a compressed air pump can also be provided which generates pressure in the brake fluid reservoir 53 or in the connecting line to the TMC. This can, expediently, be effective in any braking action or in ABS operation. A return valve 95 is built into the cover of the reservoir 53 for this purpose which closes in the event of excess pressure. Alternatively, a delivery arrangement or backing pump can also be used for this purpose, as described particularly with reference to FIGS. 1 to 3 and indicated in FIG. 5 at 9 by a dotted line.

Intake can be used not only for the ABS operation described, but also to reduce the size of the TMC where there is an intake of additional volume in the infrequently high pressure range.

When pressure is reduced in the system via the brake pedal, the previous excess volume intake is discharged by assessing the piston position and pressure via the solenoid valve 76 or 89 in order to prevent sleeve damage in the TMC.

The system with distance simulator can be designed, in contrast to the one in FIG. 5, such that the ABS effect and the associated oscillation of the TMC pistons have no retrospective effect on the brake pedal. Both brake circuits with the associated hydraulic lines 51, 52, each with a 2/2 way solenoid valve, are connected to the brake fluid reservoir 53 via return lines in the TMC for this purpose. The valves are opened if the piston 67 with the extension 68 has no free travel to the push rod 65 which can be established by evaluating the signals from the distance sensors 73, 74 and 54. In this case, hydraulic free travel clearance is initiated wherein the distance between piston and extension 68 respectively and push rod 54 is altered when volume is discharged from the pressure chamber 45 and 46 separately or in parallel via the 2/2 solenoid valves 88, 89 into the brake fluid reservoir 23. This function, which is also described in detail in DE 10 2010 045 617.9, to which reference is made here, is particularly expedient or necessary in ABS at low friction coefficient or recuperation too if the driver depresses the pedal further and the TMC piston has to travel further back in order to reach a low pressure level. A portion of the volume can be recovered again in the brake circuit if, for example, the friction coefficient changes from low to high. A small retrospective pedal effect can also be generated intentionally from the piston movement for free travel clearance purposes in order to indicate the use of ABS control to the driver. Guide the return movement of the piston to free travel=0 here and then the free control described will be controlled to the desired value or distance respectively.

### LIST OF REFERENCE SIGNS

1 Reservoir

2 Power assist

3 TMC housing

4 Push rod piston

4a Push rod circuit

5 Accumulator chamber

5a Accumulator chamber circuit

6 Return spring

7 Snifting bores

7a Small snifting bore

8 Sealing sleeves

9 preliminary pump

10 Outlet valve

11 Return line to reservoir

12 Line to wheel brake

13 Position sensor

14 Sensor target

15 2/2 solenoid valve

16 Pump piston

17 Return spring

18 Rotor mounting 1

18a Rotor mounting 2

19 Magnet yoke

20 Solenoid

21 Magnet attachment

22 Magnet rotor

23 Pressure sensor

24 Seal

25 Radial groove

26 Intake channel

31 Actuating device

32 Actuating arrangement

33 Brake pedal

34 Bearing pedestal

35 Push rod

36 Piston-cylinder unit (TMC)

37 Servo unit

38 Transmission unit or piston-cylinder unit respectively

39 Hydraulic control unit (HCU)

40 Housing

43 Piston (floating)

44 Piston (push rod)

45 Pressure chamber

46 Pressure chamber

47 Spring

48 Spring

49 Opening

50 Opening

51 Hydraulic line

52 Hydraulic line

53 Brake fluid reservoir

54 Sensor

60 Housing

61 Electric motor

62 Stator

63 Rotor

64 Ball screw

65 Push rod

66 Pressure chamber

67 Piston

68 Extension

69 Cylinder base

70 Recess

71 Element

72 Elastic member

73 travel sensor

74 travel sensor

75 2/2 way solenoid valve

76 2/2 way solenoid valve

77 Return valve

78 Accumulator chamber

81 Opening

82 Opening

83 Hydraulic line

84 Hydraulic line

85 travel simulator

86 2/2 way solenoid valve

87 Throttle return valve arrangement

88 2/2 way solenoid valve

89 2/2 way solenoid valve

90 Pressure sensor

91 Piston travel sensor

92 Sensor target

93 Pressure source

94 Air pump

95 Return valve

1. A piston-cylinder device for delivering a hydraulic fluid under pressure to an actuating arrangement of a brake system, the device having:
at least one piston configured to delimit a pressure chamber;
a hydraulic line configured to connect the pressure chamber to the actuating arrangement; and
an additional arrangement configured to supply hydraulic fluid under pressure to the pressure chamber.

2. The piston-cylinder device according to claim 1, wherein the additional arrangement has at least one electromagnetic pump configured for operation on an intermittent basis.

3. The piston-cylinder device according to claim 2, further having a reservoir, and wherein the electromagnetic pump is arranged between the reservoir and the piston-cylinder device.

4. The piston-cylinder device according to claim 2, wherein a turn on and turn off time of the electromagnetic pump is adjusted in accordance with movement of the piston in the piston-cylinder device and is actuated in response to the piston in the piston-cylinder device being returned for redelivery.

5. The piston-cylinder device according to claim 1, wherein the additional arrangement is incorporated into the piston-cylinder device.

6. An actuating device for a vehicle brake system having:
a first piston-cylinder unit including at least one working chamber configured to be connected, via at least one hydraulic line in which a valve arrangement is activated, to at least one wheel brake having associated inlet and outlet valves;
a servo unit;
an actuating arrangement including a brake pedal; and
a transmission arrangement or other hydraulic piston-cylinder unit arranged coaxially with respect to the first piston-cylinder unit,
wherein the transmission arrangement or other hydraulic piston-cylinder unit is configured to be actuated by the actuating arrangement, and
wherein the first piston-cylinder unit is configured to be actuated by means of the servo unit to supply hydraulic fluid to a brake circuit.

7. The actuating device according to claim 6, further having at least one accumulator, configured for redelivery of hydraulic fluid to the brake circuit.

8. The actuating device according to claim 6, wherein the servo unit has an electromotive drive.

9. The actuating device according to claim 6, wherein the servo unit (37) has a gearing mechanism configured to cooperate with the piston in the first piston-cylinder unit.

10. The actuating device according to claim 6, wherein the actuating device is connected to a travel simulator.

11. The actuating device according to claim 10, wherein the travel simulator is connected to a pressure chamber in the transmission arrangement or other hydraulic piston-cylinder unit.

12. The actuating device according to claim 6, further having a mechanism configured to control the servo unit and to be actuated by the actuating arrangement, wherein the mechanism has two elements configured to be moved relative to each other and between which an elastic element is arranged.

13. The actuating device according to claim 6, further having a further hydraulic line is, in which a valve arrangement is interconnected, wherein the further hydraulic line is configured to conduct the hydraulic line leading from the wheel brakes to a brake fluid reservoir.

14. The actuating device according to claim 13, further having a pressure sensor provided in the further hydraulic line.

15. Actuating The actuating device according to claim 6, comprising a tandem master cylinder arrangement having a piston travel sensor in a floating piston of the tandem master cylinder arrangement.

16. The actuating device according to claim 6, further having an arrangement provided on a brake fluid reservoir or on a connecting line from a master cylinder to a brake fluid reservoir and configured to conduct hydraulic fluid or to increase pressure.

17. A method for conducting a hydraulic fluid under pressure to an actuating arrangement of a brake system, including intermittently delivering hydraulic fluid to a pressure chamber of a piston-cylinder unit, by means of an additional arrangement.

18. A method for actuating an actuating device for a vehicle brake system having an actuating arrangement, a servo unit and a master cylinder, the method including delivering hydraulic fluid from at least one brake circuit to a reservoir and from said reservoir back into the brake circuit via at least one line leading from a reservoir to the master cylinder in which a control valve is arranged, by means of wherein said delivering includes actuating a master cylinder piston.

19. The method according to claim 18, further including briefly maintaining fluid pressure in each of multiple control modes in order to perform an intake operation, wherein the intake operation is performed during a pressure maintenance phase at least in respect of front wheels of the vehicle.

20. The method according to claim 18, further comprising redelivering hydraulic fluid depending on the piston position.

21. The method according to claim 18, further comprising generating pressure in the reservoir by means of an electric pump generating compressed air.

22. The actuating device according to claim 7, wherein the redelivery operation is performed depending on the piston position.

23. The actuating device according to claim 6, further comprising:
a brake fluid reservoir; and
an electric pump coupled to the brake fluid reservoir and configured to generate compressed air and to thereby generate pressure in the brake fluid reservoir.
